(19) United States
(12) Patent Application Publication
(10) Pub. No.: US 2007/0016323 A1
(43) Pub. Date: Jan. 18, 2007

(54) Splint and or Method of Making Same

(76) Inventor: Scott Fried, Gwynedd Valley, PA (US)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(21) Appl. No.: 11/279,494

(22) Filed: Apr. 12, 2006

Related U.S. Application Data
(63) Continuation-in-part of application No. 10/321,305, filed on Dec. 17, 2002, now Pat. No. 6,725,118.
(60) Provisional application No. 60/670,338, filed on Apr. 12, 2005.

(51) Int. Cl. G06F 19/00

(52) U.S. Cl. 700/118; 602/5

(57) ABSTRACT

Various methods, materials, and systems for providing custom splints are described herein.

### BACKGROUND

This application claims priority to and benefit of the following U.S. patent applications: (1) U.S. patent application Ser. No. 10/818,777, filed Apr. 6, 2004; (2) U.S. patent application Ser. No. 10/321,305, filed Dec. 17, 2002, now U.S. Pat. No. 6,725,118; and (3) U.S. Provisional Patent Application 60/670,338, filed Apr. 12, 2005; each of the above-identified applications is hereby incorporated by reference herein as if fully set forth in its entirety.

### BACKGROUND

The present invention is generally directed to splints and, more specifically, to new splint materials and to methods of providing custom splints. The custom splints can be used for any body part and can also be used to provide relief from carpal tunnel syndrome, tendinitis and other wrist and hand ailments.

In addition to the myriad of fractures experienced by people of all ages, millions of workers also find themselves experiencing hand and wrist pain on a frequent basis. Chronic pain can result in debilitating circumstances that drastically lower one's quality of life. Fractured bones, carpal tunnel syndrome and repetitive strain injury are some of the most common causes of chronic pain. Chronic pain can lead to depression, loss of livelihood, and scores of other secondary problems.

Allowing fractured bones to heal requires proper splinting of the body part. Custom splints are expensive and can be very time consuming to obtain. Additionally, health care networks don't have any centralized way of providing custom splints to patients.

In connection with carpal tunnel problems, most people still suffer, and have learned the hard way—after the physical toils and financial expense of surgery—that carpal tunnel is a problem with no easy surgical solution. Originally, carpal tunnel was mainly experienced by elderly people who had worked hard their entire lives, and then retired to lower activity levels. In the mid 1950's, Doctor George Phalen coined the term “carpal tunnel” to describe their condition, which was thought to be a localized nerve injury at the hand and wrist. The paradigm concerning upper extremity nerve injury taught in medical schools was “all nerve problems in the upper extremities are carpal tunnel.” Since these patients had surgery and, because of sedentary lifestyles, died at a fairly young age, the incidence of returning pain symptoms was low and surgery appeared to be a suitable cure to carpal tunnel syndrome. Dr. Phalen did not envision that the straightforward problem he diagnosed and surgically treated would become as complex to treat as it has become today.

Today, carpal tunnel surgeries are often performed with minimal attempts being made to provide a complete pre-surgical diagnosis and to provide patient education to find non-surgical alternatives. Doctors rarely consider recommending activity and lifestyle modifications. Up to thirty percent of patients have recurrent or continued problems with pain and dysfunction after surgery, yet in spite of this, many feel they cannot improve because they have already had corrective surgery.

In the past, the belief that surgery is the best option was often unquestioned. Employers and insurance carriers wanted to believe that there is a quick fix to carpal tunnel and repetitive strain injury. Surgery was encouraged and patients were not told of the failure rates. Today, the recurrence of painful symptoms after undergoing carpal tunnel surgery is thought to be as high as thirty percent.

Many people who have had surgery continue to be symptomatic, but their complaints fall upon deaf ears. Most go back to their work activities and are warned not to complain anymore, or their jobs will be jeopardized. They are told the numbness, tingling and upper arm pain that they experience are to be expected and that “if you work hard, you are going to have some aches and pains.”

The concepts of repetitive strain injury, tendonitis and carpal tunnel are misunderstood by many physicians and therapists. With the lack of knowledge and understanding of nerve injuries that permeates the medical community, patients are left to deal with the consequences—the return of their daily pain. They fall through the cracks of a system devastatingly deficient in understanding and treating these diseases.

One difficulty with finding non surgical methods to treat carpal tunnel syndrome is the need to immobilize the joint during periods of rest. While generic splints are available for immobilizing joints, such splints may result in the joint being held in a less than ideal alignment. The “cocked-up” wrist position resulting from most store bought splints fails to immobilize the wrist in a neutral position. By providing a custom splint tailored to the exact dimensions of a patient's hand, a time tested, side-effect free alternative to surgery can be used to obtain relief and healing. Custom splints also play an integral role when used with therapy and simple lifestyle modifications. One of the greatest benefits of a custom splint is that a custom splint can, in some cases, provide the needed relief to allow patients to consider non-surgical options. Unfortunately, few treatment centers have skilled personnel capable of making custom splints in a cost effective manner. Additionally, in most treatment centers, it is necessary for a patient to return for a second visit just to have the completed custom splint applied to the body.

Conventional custom splints have been made via a relatively standardized, skilled labor intensive process, done for many decades in the same manner. Conventional splints require that a cast first be taken of a patient's limb. Then, the cast is sent to a prosthetist who uses the cast to manufacture a mold that is then used to form the prosthetic or orthopedic device. Finally, a specialist reviews the molded cast and makes adjustments. This method of making conventional custom splints has many drawbacks. For example, conventional splints and splint materials have many problems, such as requiring a large amount of highly skilled labor, melting, cracking, warping and a high degree of variability in quality consistent with the skill and experience level of the treating therapist.

It would be advantageous to provide splints formed of improved materials and/or methods of providing a custom splint formed of materials that provide improved performance characteristics relative to conventional splints.

### SUMMARY

Briefly speaking, one embodiment of the present invention is directed to a method of making a custom splint for a portion of a person's body. The method includes: scanning in three dimensions a portion of the person's body for which a splint is needed to assemble at least one set of data representing an outer surface of the portion of the person's body; transmitting a signal representing the at least one set of data to a splint generating device; producing a custom splint formed layer by layer using a selective laser sintering machine directly from the at least one set of data without requiring manual adjustment during the production of the custom splint, the custom splint being contoured to complement and immobilize the portion of the person's body, the custom splint being configured for placement over the person's skin.

In a separate aspect, the present invention is directed to a method of making a custom splint for a portion of a person's body. The method includes: scanning in three dimensions a portion of the person's body for which a splint is needed to assemble at least one set of data representing an outer surface of the portion of the person's body; transmitting a signal representing the at least one set of data to a splint generating device; producing a custom splint formed layer by layer using a stereolithography machine directly from the at least one set of data without requiring manual adjustment during the production of the custom splint, the custom splint being contoured to complement and immobilize the portion of the person's body, the custom splint being configured for placement over the person's skin.

In a separate aspect, the present invention is directed to a method of making a custom splint for a portion of a person's body. The method includes producing a custom splint formed layer by layer using an automated process, the custom splint being contoured to complement and partially immobilize the portion of the person's body, the custom splint being semi-rigid to allow partial motion and being configured for placement over the person's skin, wherein the partial motion facilitates healing while still providing protection to the portion from strain caused normal use of the portion of the person's body.

### BRIEF DESCRIPTION OF THE DRAWINGS

The above summary, as well as the following detailed description of the preferred embodiments of the present invention, will be understood when read in conjunction with the appended drawings. For the purpose of illustrating the invention, there are shown in the drawings embodiments which are presently preferred. It is understood, however, that the invention is not limited to the precise arrangement and instrumentalities shown. In the drawings:

FIG. 1 is a flowchart of a preferred method of providing centralized custom splint production for a network of healthcare providers according to one embodiment of the present invention;

FIG. 2 is flowchart of a preferred method of making a custom splint for a portion of a person's body according to another embodiment of the present invention;

FIG. 3 is a perspective view of a first preferred scanner device for use with the system and/or method of the present invention; the scanner may pivot throughout the annular housing as needed to obtain a scan of an outer surface of a portion of a person's body;

FIG. 4 is a perspective view of a second preferred scanner device for use with the system and/or method of the present invention;

FIG. 5 is a perspective view of a third preferred scanner device for use with the system and/or method of the present invention;

FIG. 6 is a perspective view of a preferred fixture for use with the system and/or method of the present invention; when used, this fixture helps isolate the movement of the arm to facilitate scanning of the arm;

FIG. 7 is a perspective view of a second preferred fixture for use with the system and/or method of the present invention; when used, this fixture helps isolate the movement of the arm to facilitate scanning of the arm;

FIG. 8A is a perspective view of a third preferred fixture for use with the system and/or method of the present invention; when used, this fixture helps isolate the movement of the arm to facilitate scanning of the arm;

FIG. 8B is a perspective view of a fourth preferred fixture for use with the system and/or method of the present invention; when used, this fixture helps isolate the movement of the arm to facilitate scanning of the arm;

FIG. 9 is a schematic of a preferred system according to the present invention;

FIG. 10 is a schematic showing different interfaces that can be incorporated into the software of the present invention;

FIG. 11 is a schematic illustrating different splint parameters that can be used when making a splint according to the present invention.

### DETAILED DESCRIPTION OF THE PREFERRED EMBODIMENTS

Certain terminology is used in the following description for convenience only and is not limiting. The word “outer” and/or “outwardly” refer to directions away from or to a location on an outer surface relative to the geometric center of the referenced element and designated parts thereof. The term “transmitted” is defined as including its normal meanings, as well as, including “the storing of data into a memory storage device by a first device so that the memory storage device is then transported to a second device that reads the data in the memory storage device such that the data is effectively transmitted from the first device to the second device via the memory storage device.” The term “splint”, as used in the claims and in corresponding portions of the specification, means “a device for isolating an injured portion of a person's body and limiting motion of the injured portion to facilitate healing” and does not include orthopedic devices that are intended to preserve, guide, and correct motion between two different portions of the body to which it is attached. For example, the term “splint” does not include an orthopedic device that attaches to both the upper and lower leg and is configured to guide motion to facilitate normal walking and leg motion while wearing the device due to weakened joints or the like. The term “memory storage device” is defined to include “any one of a CD-ROM, diskette, DVD, removable hard drive, flash memory device, tape back-up or the like”. Additionally, the words “a” and “one” are defined as including one or more of the referenced item unless specifically stated otherwise. The terminology includes the words above specifically mentioned, derivatives thereof, and words of similar import.

Briefly speaking, the splints of the present invention are preferably made of various materials heretofore not used for splints, such as polycarbonate and nylon. Once the splints are fashioned their characteristics and dimensions are less likely to vary. The splints tend to maintain their shape, form and characteristics (physical) no matter what traumas they are exposed to. However, those of ordinary skill in the art will appreciate that any suitable splint material can be used without departing from the scope of the present invention.

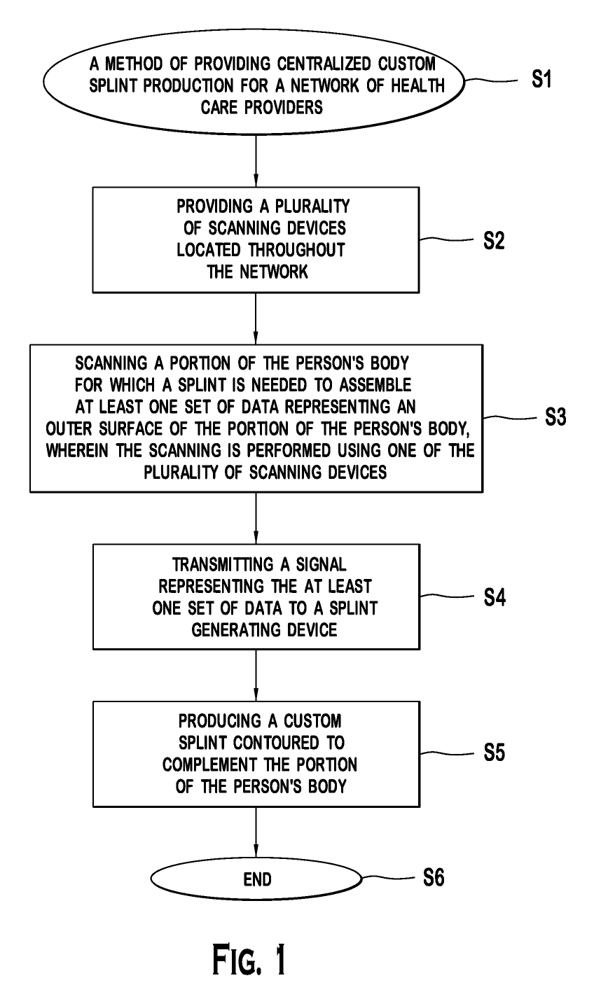

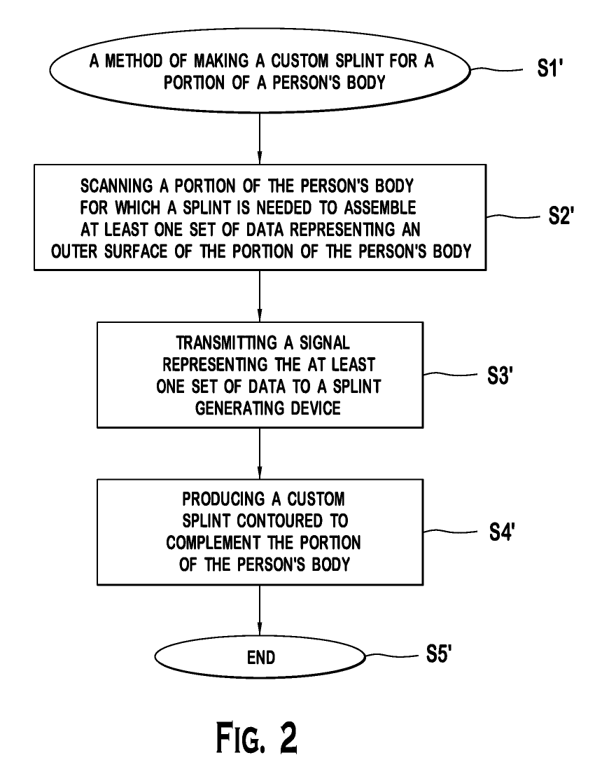

Referring to FIG. 1, a flowchart illustrating a preferred method of providing centralized custom splint production for a network of healthcare providers is illustrated. Referring to FIG. 2, a method of producing a custom splint for a portion of a person's body is illustrated.

Referring to FIGS. 1 and 2, the preferred methods of providing custom splints may include using a centralized custom splint producing device for one or more healthcare networks. The network that is serviced by the centralized custom generating device is preferably a network of healthcare providers that may be organized by region, hospital, and/or insurance carrier.

The preferred methods of the present invention preferably include the step of providing a plurality of scanning devices located throughout the network, preferably in individual offices or clinics. The scanning devices may be located within a regional hospital network to allow centralized production of custom splints or the scanning devices may be located within a regional healthcare practitioner network to allow centralized production of custom splints for the entire network. The scanning devices are preferably three dimensional image scanning devices capable of precisely measuring the outer contours of a portion of a person's body. One preferred scanner is the Minolta VIVID 910 non-contact 3-D Digitizer. Regardless of the type of scanner used it is preferred that the scanner be three dimensional; capable of taking a fast scan; and capable of forming a lattice of thousands of vertexes to allow a surface profile to be generated. The scanning devices can be designed so that one scanner can be used for any portion of a person's body, or the scanning devices can be customized for use with a person's leg, hand, wrist, and/or arm. The scanning devices can be used in conjunction with computer aided design software to define the appropriate shape of the custom splint.

The scanning devices may be connected to the splint generating device via the Internet, dial up modem connections, optical fiber connections, broadband connections, via cable, and/or any other known types of data transfer connectors. Alternatively, the data can be written onto a compact disc read only memory device or similar data storage device and transferred to the custom splint generating machine for processing and use thereafter without departing from the scope of the present invention.

The preferred methods of the present invention include scanning a portion of the person's body for which a splint is needed to assemble at least one set of data representing an outer surface of the portion of the person's body. The scanning is preferably performed using one of the scanning devices mentioned above. One example of a method of digitizing an outer surface of a portion of a person's body is disclosed in U.S. Pat. No. 5,432,703 which is entitled “laser digitizer system for producing orthodic and prosthetic devices”, which is hereby incorporated by reference herein as if set forth in its entirety. Another example of collecting at least one set of data that represents a surface is disclosed in U.S. Pat. No. 5,768,134 which is entitled “Method for Making a Perfected Medical Model on the Basis of Digital Image Information of a Part of the Body”, which is also hereby incorporated by reference herein in its entirety as if fully set forth.

The preferred methods of the present invention include transmitting a signal representing the at least one set of data to a splint generating device. As mentioned above, the transmitting of the signal can be accomplished by sending the signal via the Internet to a remotely splint generating device to facilitate centralized custom splint production for any of the networks discussed above. The splint generating device is preferably capable of creating the custom splint without requiring manual adjustment during the production of the custom splint.

The possible reduction and/or elimination of manual adjustments by trained professionals can be an advantage of the methods of the present invention. Conventional splints require that a cast first be taken of a patient's limb. Then, the cast is sent to a prosthetist who uses the cast to manufacture a mold that is then used to form the prosthetic or orthopedic device. Finally, a specialist reviews the molded cast and makes adjustments. This labor intensive process is avoided by the methods of the present invention due to the precision of the scanning of the portion of the person's body and the use of the scanned data to automatically generate a custom splint using new splint manufacturing techniques.

The step of transmitting may include transmitting the signal to a Stereolithography machine. The use of stereolithography equipment allows for rapid prototyping of the desired custom splints. Stereolithography equipment constructs the custom splints directly from the at least one data set with little if any human intervention being required. Stereolithography may use an ultra violet laser to cure liquid resin, such as a photopolymer. As the ultra violet laser traces cross-sections of the desired custom splint, the photopolymer solidifies to create a custom splint, layer by layer. The at least one data set is preferably is formatted in the STL file format used by some stereolithographic machines. The in process custom splint is generally lowered as the next bottom most layer of the custom splint is completed. The curing process is repeated until the finished custom splint is prepared. If desired, the custom splint can be post processed to create a desired finish. To increase throughput, multiple splints can be prepared by the stereolithography machine at one time.

As mentioned above, the splints of the present invention can be made of various materials such as polycarbonate and nylon. These new machine made splints can incorporate materials not previously applicable or available for making custom splints, such as nylon and polycarbonate. The process of the present invention can be used for constructing custom splints, braces and orthotics as well as orthopedic devices formed of nylon, polycarbonate, or other suitable materials. A further unique and breakthrough advantage of the process of the present invention is that it allows the manufacturing of semi rigid and flexible splints which are not currently available or constructible. The custom splints of the present invention are a marked improvement which flows from a the use of new, previously unsuitable, splinting material. The custom splints of the present invention provide increased patient comfort and splint quality. It is preferred, but not necessary, that the semi-flexible splint allow no more than thirty percent of normal motion for the partially immobilized area covered by the custom splint. More preferably, the allowed motion should be less than twenty percent of normal motion. More preferably still, the allowed motion should be less than ten percent of normal motion.

By using Stereolithography manufacturing it is possible to make splints using materials that currently cannot be used. Using one of the preferred processes of the present invention, a splint can be constructed using Stereolithography which incorporates new materials, including but not limited to nylon polymers, elastomer and polycarbonate, allowing variations of splints, which are semi rigid and flexible. In fact, semi flexible splints are unique and different than any material used today in making splints. This allows patients progressive motion, yet protection, limiting the possibility the splint will restrict the patient in a manner which might be harmful to them and yet when clinically indicated, protect them from injury or furthering their injuries. These splints of the present invention are relatively indestructible in normal circumstances and are resistant to melting, impact damage, and damage from hot water and solvents. They are easily cleaned which improves the ability to avoid infection and contamination and makes them and much more sanitary device.

The splints of the present invention do not melt at routinely encountered temperatures. They are much more resistant to cracking, bending and breaking. They are machine washable, dishwasher safe and allow greater sanitary function and are easily cleaned. The splints of the present invention will not change in shape it stressed under warm conditions thereby making care and use of them much easier and versatile. Custom scanned nylon hard splints manufactured according to one embodiment of the present invention can be appropriately used for patients who have problems like carpal tunnel syndrome, tendinitis, fractures, soft tissue injuries, postoperative patients and wrist or hand pain, to name a few indications.

Some examples of patients appropriate for softer, semi-flexible splints would include, but are not limited to, patients with carpal tunnel and tendonitis, who are returning to work activities. Also athletes with fractures could wear the protective device on the field, in that it would afford protection but not injure other players due to the soft nature of the splint. It would protect what is within, much better than taping, but not be harmful if impacting another player. This material is also appropriate for use of foot orthotic devices in that it is soft yet extremely durable.

It is preferred that the custom splints are manufactured using an automated process to form the custom splint layer by layer. Two methods of forming the custom splint layer by layer are stereolithography and selective laser sintering. However, those of ordinary skill in the art will appreciate from this disclosure that any suitable fabrication method can be used without departing from the scope of the present invention. It should also be understood that features of splint construction and design described herein for one manufacturing process may be equally applicable to splints manufactured by other manufacturing processes unless specifically stated otherwise.

One preferred method of making splints is on a rapid prototyping machine. This is called Selective Laser Sintering machine. Loaded in the Selective Laser Sintering machine is preferably a powder, which is either a nylon polymer or a glass filled polymer of a nylon base. The chamber fills with a powder and then the laser heats up a specific area, which then causes the powder to lay down sequential very thin layers of material, resulting in a base for the splint. The shape of the splint is guided by the data set produced by scanning a portion of the person's body. Eventually, the laser causes the powder to solidify in the pre-determined and preset areas that become ultimately the custom splint. The rest of the powder returns to the machine to be reused. The powder is laid down in a continuous sweeping process over multiple times, laying down in minute layers, a millimeter or less in thickness until the appropriate thickness of splint is built. This begins at the base or bottom of the chamber and adds in thickness, “building up” in dimension until the splint is at least substantially manufactured. What can result from the method of the present invention is a solid splint made of either glass filled nylon or solid nylon material. This material has the physical qualities described in chart form in the following section. However, those of ordinary skill in the art will appreciate from this disclosure that the custom splint can be formed of any suitable material without departing from the scope of the present invention.

### Preferred Selective Laser Sintering (Selective Laser Sintering) Material Properties

The following properties are provided for a preferred splint material which may be a polyamide (filled or unfilled) or Nylon or the like. As detailed above, the splint material can be varied without departing from the scope of the present invention.

General Properties

Specific Gravity @ 20° C. (ASTM D792) 0.95 g/cm31.25 W=3 0.91 glans 0.86 glans

Moisture Absorption @ 23° C. (ASTM D570) 0.41% 0.35% 0.06%

Powder Density, Tap (ASTM 04164) 0.44 W=3 O.U.60=30.M Wm 4.

Average Particle Size (Laser Diffraction) 58 pm 48 pm 93 pm 62 pm

Particle Size Range (Laser Diffraction) 60 pm 60 pm 23-190 pm 25-106 pm

Thermal Properties

Melting Point: Tm (DSC)184° C. 184° C. 156° C. 89° C. DTUL, 0.45 MPa (ASTM 0648)177° C. 175

° C. 33° C. OWL, 1.82 MPa (ASTM D648) 86° C. 110° C. 40° C. Flash Point 350° C.

Autoingition 410° C.

Mechanical Properties

Tensile Strength (ASTM D 638) 45 MPa 45 MPa 2840 kPa

Tensile Modulus (ASTM D 638)1,700 MPa 3300 MPa) 15.5 MPa

Stress (5% strain=1.8 MPa

Stress (10% strain=2 MPa

1604 MPa Tensile Elongation @ break (ASTM D 638)15% 6% 110%

Flexural Modulus (ASTM D 790)1,300 MPa 2,200 MPa @ −0° C.=23 MPa @ 23° C.=13.4 MPa @100oC=3 MPa

Impact Strength

Notched Izod (ASTM D 256)

Unnotched Izod (ASTM D256)

220 J/m 440 J/m 150 J/m 200 J/m 11 J/m 14 J/m

Initial Tear Resistance (ASTM 01004)

Die C@23° C.

DieC@100° C.

6 kN/m 5.2 kN/m

Abrasion Resistance (ASTM D4060)

Taber, CS-17 wheel, 1 kg load

Taber, H-18 wheel, 1 kg load

520 me 0%0 cycles

870 mg11000 cycles

Shore Hardness (ASTM D2240) 45 Shore °D° 48 Shore “D° 74 Shore °A” Surface Finish (upper facing)

As Selective Laser Sintering Processed, Re

After finishing, Re 8.5 pm 0.13 pm 6.2 pm 1.0 pm 13.0 pm 3.0 pm

Electrical Properties

Volume Resistivity (@22° C., 50% RH, 500V) (ASTM D257-93)

3.1×1014 ohm×cm 2.3E×10,4 ohm×cart Surface Resistivity (@22° C., 50% RH, 500V) (ASTM D257-93)

3.0×1014 ohm×cm2.5E×1014 ohm×cm Dielectric Constant (@22° C.,50% RV,5V 1000 Hz) (ASTM D150-95)

2.9 3.3

Dielectric Strength (@22° C., 50% RV, in air, 5V V/sec) (ASTM D149-95A, method A) 1.6×1041.5E×104

Natural (unpainted) color White I Off We Gray tone Off

Once the splints are built they are preferably removed from the chamber and a cooling process is undertaken. The next part of the process removes the excess powder from the splints. Once this is completed then the splints may be smoothed or sanded or coated, if desired. Alternative coatings may be an elastic coating or strictly a smoothing process to allow refining the surface. Color powder or nylon base can be used to color the custom splint. It should be noted that any shapes, decorative or functional etchings, holes or variations that are specifically part of the data fed to the Selective Laser Sintering machine, will be directly incorporated into that splint. This allows complete custom splinting and variations of the splints, such as inclusion of the thumb, digits, elbow, ankle and the like.

The Selective Laser Sintering machine using the nylon polymer is capable of making hard or soft flexible splints. If a soft rather than hard splint is desired a slightly different material is used in the Selective Laser Sintering machine. This is still a nylon polymer but results in a soft flexible splint rather than the harder more rigid type. The process for building the splint though it essentially is the same as described above, although the product is unique. This splint has totally different physical qualities. Although it is built in the same manner as above this is a flexible soft splint and the material much softer to touch. The building process is the same but the resultant splint is unique and different than any hard splint or other prefabricated splint available today.

The Stereolithography machine makes splints of a nylon polymer material, which is relatively brittle but still durable, and clinically appropriate. This machine builds splints a layer at a time sweeping and laying down a very thin layer of nylon polymer. Continuous sweeps are made until this is built up completely to a full formal splint. This process allows only building of splints using the specific material unique to that machine. This is different than the Selective Laser Sintering machine, which allows different polymers to be used and the creation of soft or hard splints. No powder needs to be removed during this process so it is cleaner but more limiting. In the future as newer materials become available and these machines become more efficient this may become the preferable method of creating splints.

Another material from which splints can be made on the Stereolithography machine is polycarbonate. The polycarbonate material is built a layer at a time with multiple fine layers of polycarbonate fiber, resulting ultimately in the splint of the present invention. As with each of these devices, the splint, once manufactured, if dissected or cut open, would preferably be homogeneous or uniform throughout. Velcro straps are simply attached to the finished splint product.

Another preferred splint material according to the present invention is a nylon built on the Selective Laser Sintering machine. Multiple splints can be made at one time and these are built to the exact parameters set by the scanned data. Hard or soft splints can be built on this machine.

Polyamide (nylon) thermoplastic resins offer an excellent balance of processibility and performance properties. Two of the types of nylon used to make a splint according to the present invention is nylon 6 (PA 6) and nylon 6,6 (PA 6,6). Material properties can be varied depending on the end-use splint applications for these resins. For example, extra toughness or heat resistance can be provided if the splint is to be used by a firefighters

One of the advantages of the Selective Laser Sintering process of the present invention is that by changing the heating parameters the splints can be either more rigid or flexible. The flexible splints of the present invention feel much like a rubber and are very bendable and soft. This is comforting to the patient but also does provide support. This advantage has not previously been available in custom-made splints which did not allow partial motion. The splint of the present invention allows partial motion which can be used to protect the injured body part without rigidly immobilizing it.

Polycarbonate and other materials usable in the Selective Laser Sintering and/or Stereolithography splint manufacturing process of the present invention can also be used to create the splints of the present invention. The splints may be completely solid or have perforations added to allow improved breathability and comfort to the patient. Various designs can be placed on the splints, from the patient's name, to the doctor or therapist's office name, to their favorite sports team. These are all added as part of the program and information sent to the machine and build in the splints.

An alternate way of providing splints using the material of the present invention is to have a predetermined and preset span of prefabricated splints made. These could be made of multiple dimensions, similar to the sizing either for a hand or foot that we would use for gloves or shoes (for example sizes five, 5½, 6, 6 ½, 7, etc.). Instead of having simply a small medium and large, multiple sizes could be pre-made and kept on hand in a therapy or doctor's unit, or delivered to the patient after either being scanned or measured. Multiple and sequential sizes could be made available as created through templates. Templates can also be provided for splints of fingers, forearms, feet, ankles, or any other body part. The same custom materials could be used to make an orthotic device to be used in the foot. The softer splint material would be especially applicable to foot splints.

The splint of the present invention can be made through either an Stereolithography or Selective Laser Sintering machine. Various classes of polymers and thermoplastic elastomers can be used in the Selective Laser Sintering machines to produce the custom splints.

The soft of semi-flexible splints of the present invention can be made from a thermoplastic elastomer powder using the Selective Laser Sintering machine. One preferred splint material is SOMOS 201 thermoplastic elastomer material. SOMOS 201 thermoplastic elastomer material, is useful for forming flexible, functional parts with rubber-like performance characteristics, directly in a Selective Laser Sintering system. Together SOMOS 201 and the Selective Laser Sintering system eliminate the costs and lead times of pre-production tooling by facilitating testing and optimization of designs before tooling. Using SOMOS 201 or similar thermoplastic elastomers allows the splint of the present invention to have a flexible rubber like feel. This is a typical elastomer product and other similar materials may be substituted. There are other thermoplastic elastomer products available and other semi synthetic rubber like compounds, which are also appropriate for building semi-flexible splints. This product is presented as an example of a group of like materials.

Preferred properties of the SOMOS 201 material are as follows. Those of ordinary skill in the art will appreciate that the following properties can be varied or other materials used without departing from the scope of the present invention.

| | | UNITS | TEST METHOD | SOMOS 201⁽¹⁾ | [symbol] ⁽²⁾ |
|---|---|---|---|---|---|
| Powder Properties | | | | | |
| Density Tap | | g/cm³ | ASTM D4164 | 0.58 | |
| Particle Size Average^{(1) d}₅₀(3) | | μm | Laser Diffraction | 93 | |
| Particle Size Range⁽¹⁾ 90% | | μm | Laser Diffraction | 23-190 | |
| Specific Gravity 20° C. | | | ASTM D792 | 0.91 | 1.07 |
| Thermal Properties | | | | | |
| Melting Point: Tₘ | | ° C. | DSC | 156 | |
| Mechanical Properties | | | | | |
| Tensile Modulus | | MPa | ASTM D638 | 15.5 | 17.3 |
| Tensile Elongation at Break | | % | ASTM D638 | 110 | 130 |
| Stress at 5% strain | | MPa | ASTM D638 | 1.8 | 2.2 |
| Stress at 10% strain | | MPa | ASTM D638 | 2.0 | 2.6 |
| Flexural Modulus | at −40° C. | MPa | ASTM D790 | 23 | 37.3 |
| | at 23° C. | MPa | ASTM D790 | 13.4 | 14.1 |
| | at 100° C. | MPa | ASTM D790 | 3 | 7 |

Initial Tear Resistance

| | | | | |
|---|---|---|---|---|
| Die C at 23° C. | kN/m | ASTM D624 | 6 | 23.1 |
| Die C at 100° C. | kN/m | ASTM D624 | 5.2 | 6 |
| Abrasion Resistance | | | | |
| Taber, CS-17 wheel, 1 kg load | mg/1000/cycles | ASTM D4060 | 520 | 0.3 |
| Taber, H-18 wheel, 1 kg load | mg/1000/cycles | ASTM D4060 | 870 | 0.5 |
| Bursting Strength (Straight) | kPa | ASTM D380 | 0 | >160 |
| 23° C. 25 mm ID × 2 mm thick × 300 mm long hose | | | | |
| Shore A Hardness 23° C. | | ASTM D2240 | 74 | 75 |

| Electrical Properties | UNITS | TEST METHOD | SOMOS 201⁽¹⁾ |
|---|---|---|---|
| Volume Resistivity | ohm × cm | ASTM D257-93 | 1.5E+13 |
| 22° C. 50% RH, 500 V | | | |
| Surface Resistivity | ohm × cm | ASTM D257-93 | 1.9E+13 |
| 22° C. 50% RH, 500 V | | | |
| Dielectric Constant | | D150-95 | 2.9 |
| 22° C. 50% RV, 5 V 1000 Hz | | | |
| Dielectric Strength | v/mm | D149-95a | 4.1E+3 |
| 22° C. 50% RH, under oil 500 V V/sec | | | |
| Comparative Tracking Index | V | D5288-92 | 315. TI—Cu |
| | | and/or IEC | <3 mm depth |
| | | Standard 112 | |

For the rigid or hard splints, one material that is preferred is a polamide (nylon) thermoplastic resin. Using the methods of the present invention, nylon thermoplastic resins can be adapted to the making of custom splints.

The building of custom splints layer by layer in either an Stereolithography or Selective Laser Sintering process is unique and new to the manufacturing methods of the present invention. The use of these techniques also allows an increase in the types of materials that can be used to form custom splints. Additionally, the method of the present invention may be used to produce custom splints that are stronger, resistant to damage and melting, and/or more durable and machine made.

As an alternative to using Stereolithography or Selective Laser Sintering, the signal can be transmitted to a custom splint generating device that incorporates computer numerical control equipment. Computer numerical equipment typically replaces one or more manufacturing processes by integrating multiple operator steps into a single machine. This allows for increased throughput relative to the individual construction of the custom splint. Computer numerical equipment will essentially carve the splint out of a block of material, such as polyethylene. To minimize waste, different size blanks, or templates, can be provided so that depending on the size of a particular custom splint, the nearest sized template can be selected.

Another method of making the custom splint is to use a model hand and/or arm (hereinafter referred to as “the model”) that changes in size and shape depending on the measurements contained in the signal. This allows the model to be properly sized to have the splint formed or pressed on the model.

Alternatively, the signal can be transmitted to a custom splint generating device formed by a pin die manufacturing machine. A custom splint pin die manufacturing machine uses multiple pins that are controlled to vary the heights thereof. A polyurethane blanket or the like is placed over the pins to prevent them from forming dimples in the resulting custom splint and then the splint is molded thereon.

Another method of making custom splints is to position a moldable polymer on a malleable base, such as silica, sand, clay, or the like. A machine then presses the moldable polymer into the base while the machine uses a scanner to ensure that the polymer is suitably shaped. The machine can travel over the length of the polymer pressing down on the polymer in multiple locations until the entire polymer is properly shaped to provide the proper mold for the desired splint. Various post molding treatments are available to ensure that the polymer has the proper characteristics to serve as a mold. Alternatively, a laser can be used to cut a desired pattern on a disposable mold that is then used to prepare the needed splint.

The methods of the present invention include the step of producing the custom splint which is contoured to complement the portion of the person's body that was scanned by the scanning device. Those of ordinary skill in the art will appreciate from this disclosure that the custom splint can be produced for any portion of a person's body, such as arm, a leg, a hand, a wrist, or the like.

The methods of the present invention may include the step of sending the custom splint to a home or work address for the person for whom the custom splint is prepared. This allows for the quickest delivery of the custom splint to the end user. It is preferable that the methods of the present invention include the step of providing directions for the person for whom the custom splint is designed to enable that person to properly attach the custom splint without returning to a physician or hospital. Additionally, the methods of the present invention may include storing the custom splint data to allow easy construction of additional splints on an as needed basis for those prone to further injury, such as professional athletes.

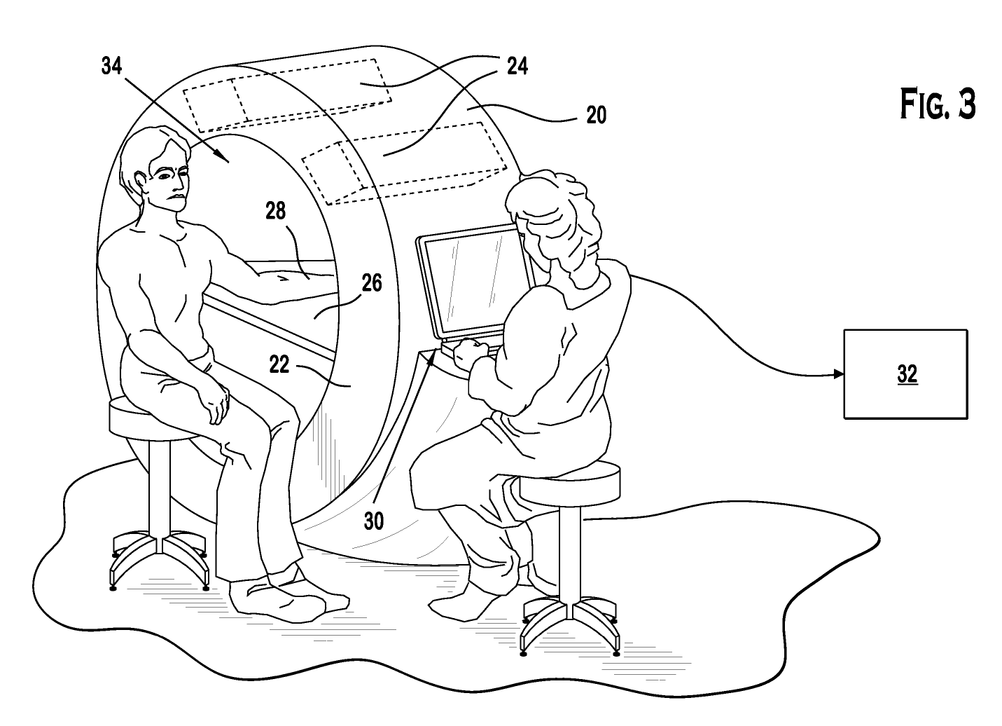

Referring to FIG. 3, one preferred scanner device 20 includes a housing 22 and a moveable three dimensional scanner 24. Multiple three dimensional scanners 24 can be used simultaneously without departing from the scope of the present invention. The use of multiple scanners 24 can eliminate the need for moving scanners while still allowing complete scanning of the portion 28 of a person's body. The three dimensional scanner 24 is preferably moveably positioned about a fixture 26. The fixture is preferably transparent and may be positioned to allow a portion 28 of a person's body to be placed thereon.

A processor 30 can be positioned on the housing 22 or remotely located. A splint generator 32 is preferably in communication with the processor 30, but can also receive signals and/or data sets directly from the scanner 24.

The splint generator 32 is preferably able to directly produce splints from the data set or computer model from the processor 30 and/or scanner 24 without requiring a skilled technician. The automatic splint generator 32 can also be used to create a design on the outside of the splint which can even be selected by the person for whom the splint is for. The design can be colored or fairly ornate as desired. This additional feature allows for superior custom splints 48 to also include an attractive design 46 that complements various fashion themes. Since multiple splints can be ordered using on data set, a person can select multiple outer surface splint designs to allow for different splints to be worn at different times and to different events.

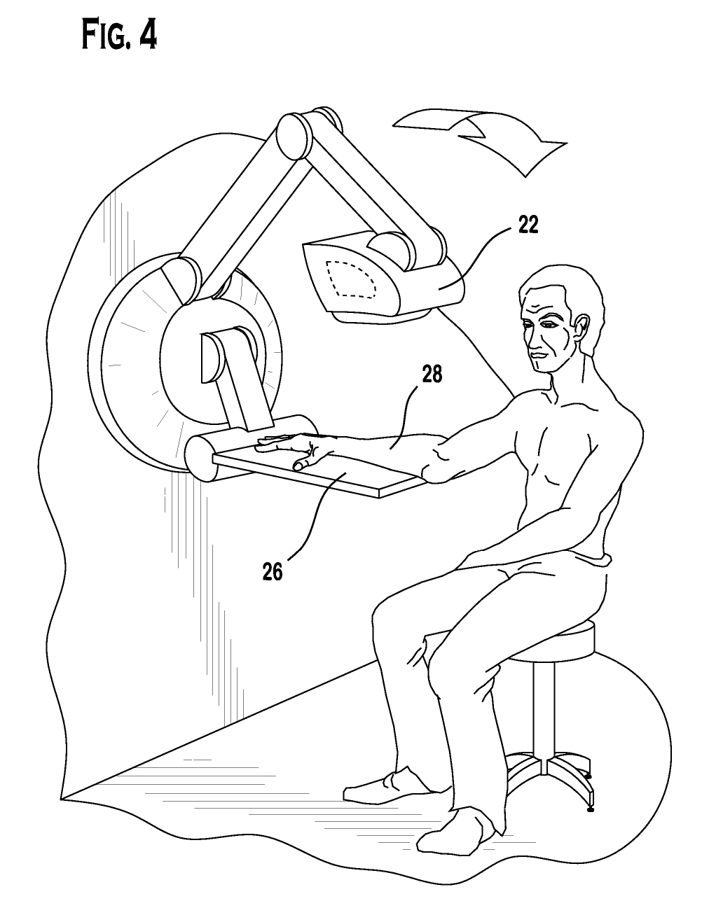

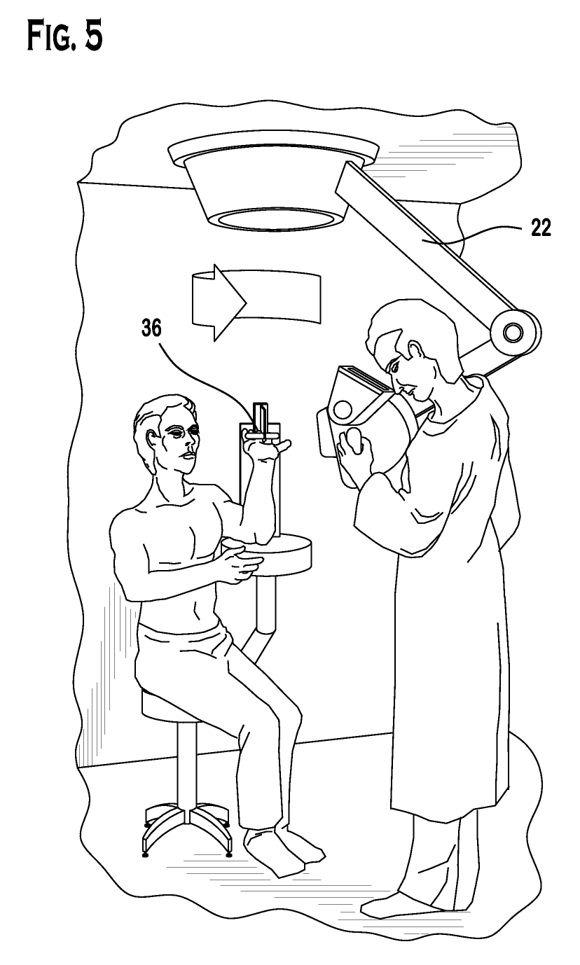

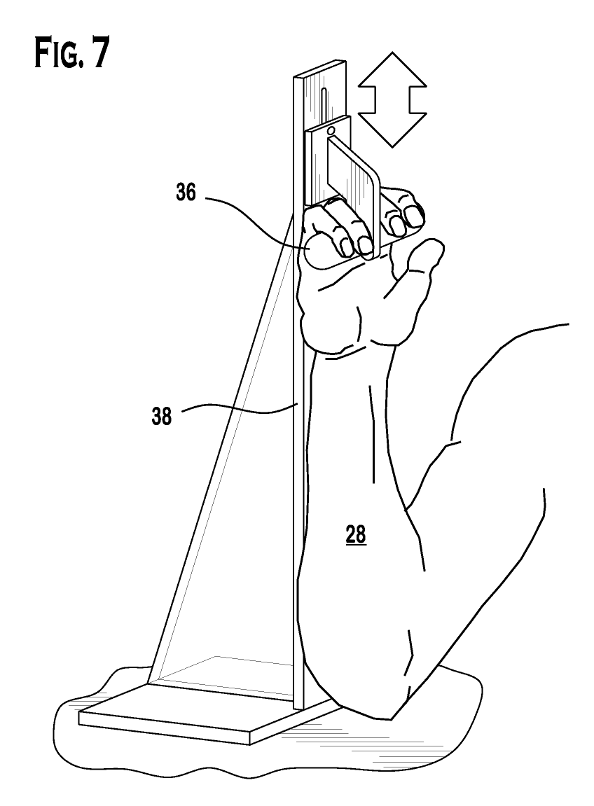

The scanner housing 22 is preferably annular in shape to define a bore 34 therein for receiving the portion 28 of the person's body. Referring to FIGS. 4 and 5, the scanner housing can be formed by an articulated arm that is either wall or ceiling mounted. It is preferable that the scanner housing 22 can be moved during scanning as desired. FIG. 5 illustrates a vertical fixture 38 (also shown in FIG. 7) that preferably includes an adjustable hanging bar 36. The hanging bar allows a user to secure a forearm in a vertical orientation.

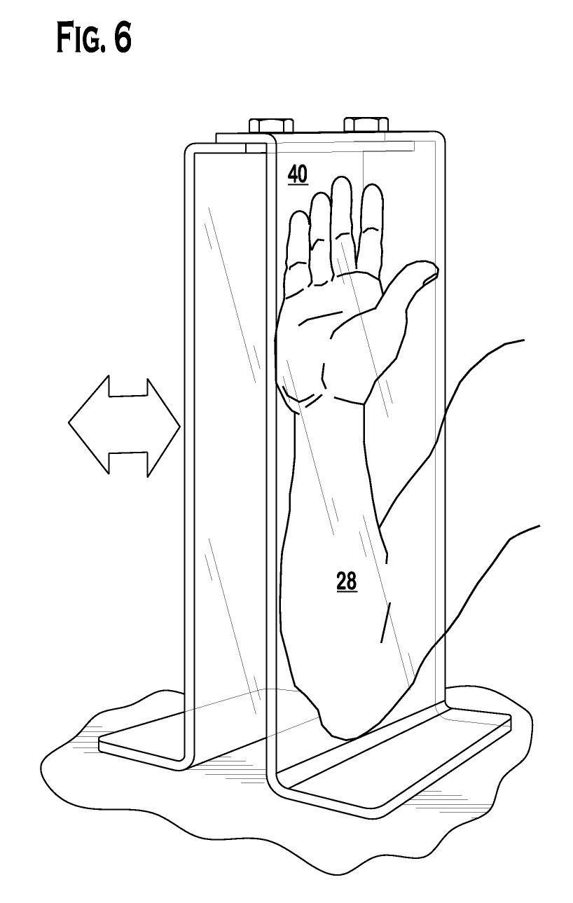

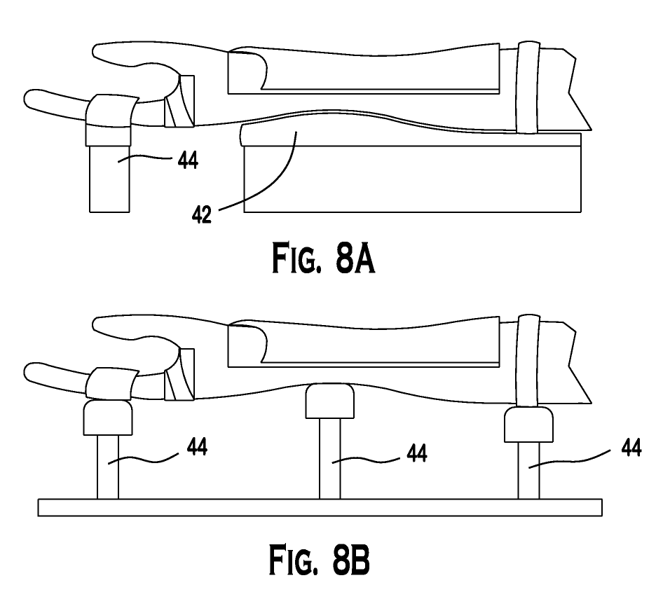

Referring to FIG. 6, an alternate fixture 40 is shown that is generally U-shaped to allow a person to insert a portion 28 of the person's body therein. It is preferred that the fixture 40 be generally transparent or generally transparent. FIG. 8A shows a fixture formed by a contoured surface 42 and separate post 44. FIG. 8B shows a fixture formed by multiple separate posts 44.

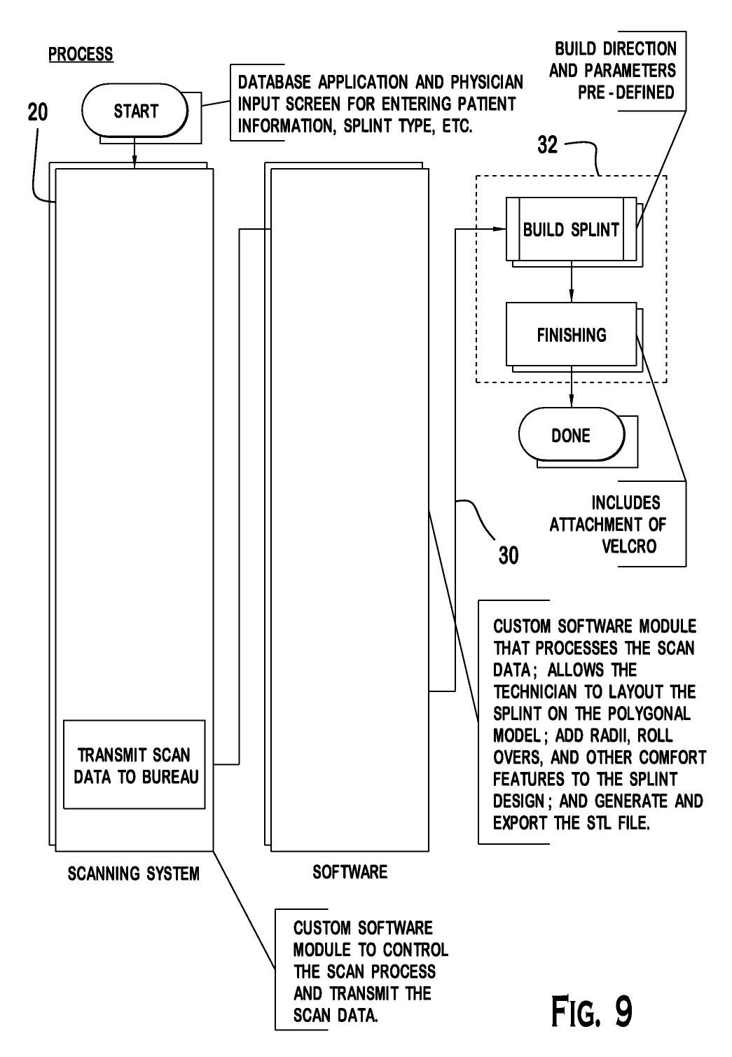

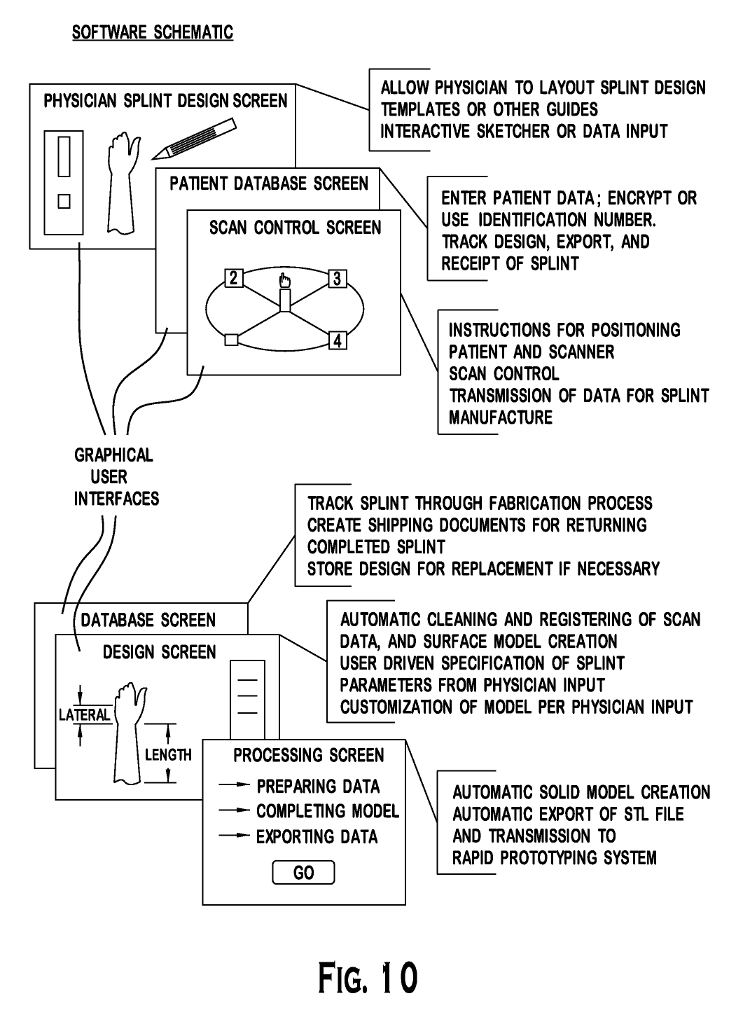

Referring to the schematic of FIG. 9, a preferred system for use with the present invention is shown. The software preferably includes graphical user interfaces that facilitate modification of a computer model of the custom splint prior to generation of the splint. FIG. 10 illustrates some preferred graphical user interfaces. The splint generator can be configured to complete the entire splint generation process or some low skill tasks, such as adding hook and loop material, can be done manually.

The present invention can obtain the geometry of a portion 28 of a person's body and convert the geometry into a splint designed to treat a particular medical condition. The inventive system can also export data to allow the splint to be built using rapid prototyping technologies and track the design, construction, and delivery of the splint. The processor 30 preferably includes a set of software modules that process the geometric data and allow the doctor and/or technician to interactively design the splint, as well as tracking the progress of each splint during manufacturing.

The scanning device 20 of the present invention can be located at a variety of doctors' offices or other locations and can preferably transmit scan data (or preferably geometric data) to a splint generator 32 which may be remotely located. As such, it is preferred that interfacing software be located on the canning device 20 and the splint generator 32.

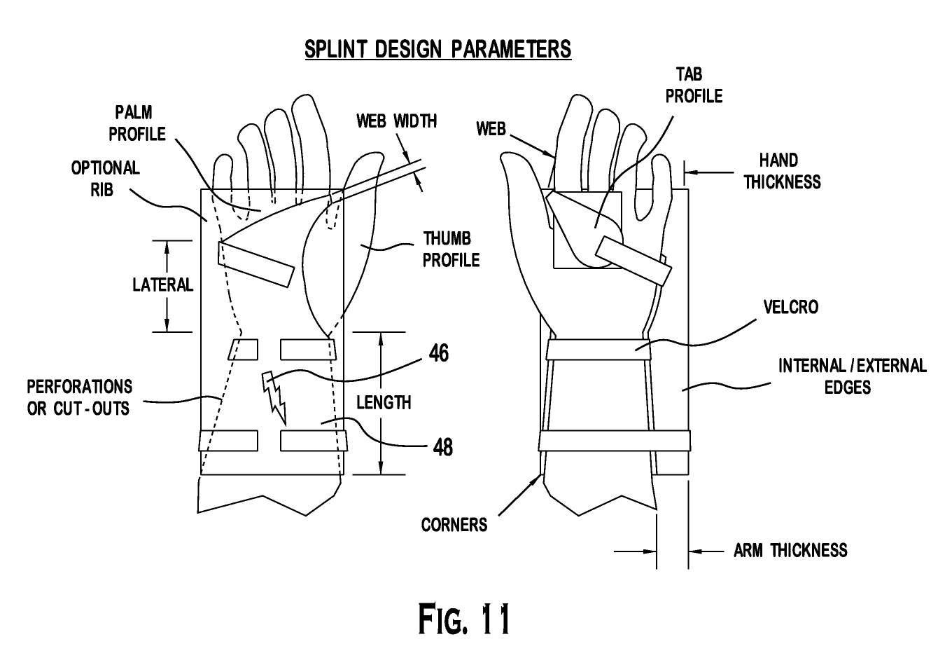

At the scanning device locations, it is preferable, but not necessary, that the software includes: a database for entering patient information and system generated encrypted codes to identify each patient; an interactive, graphical splint design capability for the physician and/or technician to specify the type of splint and any special design parameters (see FIG. 11 which illustrates various splint design parameters); a scan control and information system to assist the technician in positioning the patient, scanner, and obtaining surface geometry data; and preferably a mechanism for transmitting the geometry data to a remotely located splint generator 32. It is also preferred that the processor be capable of tracking the progress of the splint production including: monitoring the transmission of data to a remote splint generator 32; completion of a custom splint; shipping of the splint; and delivery/fitting of the splint to the patient. Referring to FIG. 10, graphical user interfaces for various aspects of some desired software modules are shown.

A the splint generator it is preferable that a software module include: a database for tracking receipt of a data set; design, manufacture, and shipping of the completed splint using a patient code number or the like as a primary key. This preferably includes the ability to store a design for modification and/or remanufacture at a later date.

The software preferably includes modules for creating the necessary documentation to accompany the splint and for shipping the splint back to the ordering physician. For example the software preferably includes modules for: an interactive, graphical splint design capability for specifying dimensional and design parameters of the splint; automatic (or semi-automatic) processing of the surface geometry data, including cleaning and registering the scans and creating a surface model from the data; automatic creation of a solid model from the surface model and splint design parameters; automatic creation and export of an STL file for building the splint using rapid prototyping technologies.

While various components of the processing and controls for the system of the present invention are described above as using a single overarching software program with several sub modules, those of ordinary skill in the art will appreciate that multiple separate software programs/modules can be used together as desired to implement the present invention.

It is recognized by those skilled in the art, that changes may be made to the above described embodiments without departing from the broad inventive concept thereof. It is understood, therefore, that this invention is not limited to the particular embodiments disclosed, but is intended to cover all modifications which are within the spirit and scope of the invention as defined by the appended claims and/or shown in the attach ed flowcharts.

What is claimed is:

1. A method of making a custom splint for a portion of a person's body, comprising:
scanning in three dimensions a portion of the person's body for which a splint is needed to assemble at least one set of data representing an outer surface of the portion of the person's body;
transmitting a signal representing the at least one set of data to a splint generating device;
producing a custom splint formed layer by layer using a selective laser sintering machine directly from the at least one set of data without requiring manual adjustment during the production of the custom splint, the custom splint being contoured to complement and immobilize the portion of the person's body, the custom splint being configured for placement over the person's skin.

2. The method of claim 1, wherein the step of producing the custom splint further comprises the custom splint being generally rigid when worn by the person and not allowing for motion between portions of the body onto which the splint is attached.

3. The method of claim 1, wherein the step of producing the custom splint further comprises the custom splint comprising a polyamide nylon.

4. The method of claim 1, wherein the step of producing the custom splint further comprises the custom splint comprising a polycarbonate.

5. The method of claim 1, wherein the step of producing the custom splint further comprises the custom splint comprising SOMOS 201.

6. The method of claim 1, wherein the step of producing the custom splint further comprises the physical properties of the custom splint being adjusted through selection of a splint material based on intended use of the custom splint.

7. The method of claim 1, wherein the step of producing the custom splint further comprises the custom splint comprising nylon.

8. The method of claim 1, wherein the step of producing the custom splint further comprises the selective laser sintering machine placing an ornamental design on an outer surface of the custom splint.

9. A method of making a custom splint for a portion of a person's body, comprising:
scanning in three dimensions a portion of the person's body for which a splint is needed to assemble at least one set of data representing an outer surface of the portion of the person's body;
transmitting a signal representing the at least one set of data to a splint generating device;
producing a custom splint formed layer by layer using a stereolithography machine directly from the at least one set of data without requiring manual adjustment during the production of the custom splint, the custom splint being contoured to complement and immobilize the portion of the person's body, the custom splint being configured for placement over the person's skin.

10. The method of claim 9, wherein the step of producing the custom splint further comprises the custom splint comprising a polyamide nylon.

11. The method of claim 9, wherein the step of producing the custom splint further comprises the custom splint comprising a polycarbonate.

12. The method of claim 9, wherein the step of producing the custom splint further comprises the custom splint comprising SOMOS 201.

13. The method of claim 9, wherein the step of producing the custom splint further comprises the custom splint comprising nylon.

14. A method of making a custom splint for a portion of a person's body, comprising:
producing a custom splint formed layer by layer using an automated process, the custom splint being contoured to complement and partially immobilize the portion of the person's body, the custom splint being semi-rigid to allow partial motion and being configured for placement over the person's skin, wherein the partial motion facilitates healing while still providing protection to the portion from strain caused normal use of the portion of the person's body.

15. The method of claim 14, wherein the step of producing the custom splint further comprises the custom splint comprising a polyamide nylon.

16. The method of claim 14, wherein the step of producing the custom splint further comprises the custom splint comprising a polycarbonate.

17. The method of claim 14, wherein the step of producing the custom splint further comprises the custom splint comprising SOMOS 201.

19. The method of claim 14, wherein the step of producing the custom splint further comprises the automated process being one of stereolithography and selective laser sintering.

20. The method of claim 14, wherein the step of producing the custom splint further comprises the splint being semi-rigid and allowing no more than thirty percent of normal motion.

21. The method of claim 14, wherein the step of producing the custom splint further comprises the splint being semi-rigid and allowing no more than twenty percent of normal motion.

22. The method of claim 14, wherein the step of producing the custom splint further comprises the splint being semi-rigid and allowing no more than ten percent of normal motion.

23. The method of claim 14, wherein the step of producing the custom splint further comprises the custom splint being formed from cured liquid resin.

24. The method of claim 14, wherein the step of producing the custom splint further comprises the custom splint being configured for cleaning in a dishwasher while still being suitable for use afterwards.
